(19) United States
(12) Patent Application Publication
(10) Pub. No.: US 2015/0286486 A1
(43) Pub. Date: Oct. 8, 2015

(54) SYSTEM AND METHOD OF GUIDING A USER IN UTILIZING FUNCTIONS AND FEATURES OF A COMPUTER-BASED DEVICE

(71) Applicant: Symmpl, Inc., Los Angeles, CA (US)

(72) Inventors: Jay Smith, III, Pacific Palisades, CA (US); Anson Sims, Granada Hills, CA (US); Nicholas W. Goehner, Los Angeles, CA (US); Brian S. Braff, Santa Monica, CA (US); John M. Keating, Santa Monica, CA (US)

(21) Appl. No.: 14/593,261

(22) Filed: Jan. 9, 2015

Related U.S. Application Data
(60) Provisional application No. 61/964,820, filed on Jan. 16, 2014.

(51) Int. Cl. G06F 9/44; H04L 29/08

(52) U.S. Cl. CPC G06F 9/4446; H04L 67/10; H04L 67/02

(57) ABSTRACT

A system/method is provided for guiding a user in utilizing functions of a computer-based device. A memory of the device stores non-user data and/or user data that includes inputs of the user using the computer-based device and/or inputs provided by a helper of the user using a remotely located computer-based device. A processor of the device is configured to operate a software application having instructions for interacting with an operating system or software code using an application programming interface. A display is provided for displaying dialogs for guiding the user. A speaker is provided for outputting audio information helpful to the user. The processor is configured to dynamically determine the dialog and audio information based on the user and non-use data, and modify displayed elements. Requests for inputs to be provided by the user are simplified and presented step-by-step in an intuitive manner.

### CROSS REFERENCE TO RELATED APPLICATION

This application claims the priority benefit of U.S. Provisional Application No. 61/964,820 filed on Jan. 16, 2014, the entire disclosure of which is herein incorporated by reference as a part of this application.

### BACKGROUND OF THE INVENTION

1. Field of the Invention

The present invention relates to methods and systems for assisting a user in utilizing functions of a computer-based device and guiding the user in utilizing various functions of the computer-based device.

2. Description of Related Art

Computer-based devices such as smart phones and tablet computers have become an integral part of daily life. Users with a wider range of technical background are interested in utilizing computer-devices for a variety of functions, such as email communications and media sharing. Unfortunately, computer-based devices have been traditionally designed for technically savvy users. More particularly, the systems are designed with the assumption that the users know the basic operation of the computer and have the ability to interpret the input choices presented to the users. For users without adequate technical expertise, such as an elderly user without sufficient prior exposure to use of computer-based devices, using a computer-based device can be a daunting task. The type and number of inputs needed from the user for completing a task can make the user experience overwhelming. The required inputs to accomplish a task and the corresponding graphic interface are difficult to discern for non-technical users. Tablet computers and smart phones include various built-in and pre-configured software applications that are not intuitive for use by a non-technical user.

There is a need in the art for a software-based method and system of guiding a user in utilizing various functions of a computer-based device in an intuitive fashion.

### SUMMARY OF THE INVENTION

The present invention guides a user with a limited technical understanding in utilizing a computer-based device. For users without adequate technical expertise using a computer-based device that offers a variety of choices without a clear explanation can be a daunting task. As explained in further details, the computer-based system takes over the operation of the device and prevents the user from getting lost in the maze of alternatives present on most computer-based devices. A software-based host serves as a personal assistant for the user, thereby automatically guiding the user, step by step, through various available activities. The software-based host advantageously provides intuitive and clearly explained choices for the user. A limited number of activities are offered to the user, and the computer-based host guides the user during each activity. The software is designed to simplify choices by explaining the choices and presenting the choices step-by-step, in an intuitive fashion. The information is displayed via elements having simple graphics. Alternatively or in addition, information can be outputted via an easy-to-follow audio message in a manner which would be intuitive for a user without adequate technical understanding. In certain embodiments, choices are offered one at a time, for example, in form of buttons with simple graphics.

The invention advantageously personalizes the user experience by dynamically determining relevant and helpful information that a user with limited technical expertise would be interested in receiving. The information is determined based on data learned about the user and further based on non-user data such as current date, time, location, and various other types of information. The user data and non-user data can be updated as needed and accessed from a remote memory or from the Internet. The information can be displayed to the user and/or conveyed via voice generated using a speaker of a computer-based device in an intuitive manner. The software-based host simplifies various tasks for the user by dynamically displaying dialogs to the user and speaking to the user. Display elements can be modified based on the dialogs in order to direct user's attention to certain elements or convey other information about display elements to the user. The combination of the foregoing means of outputting information simplifies user experience.

In one embodiment, the system offers a limited number of activities in order to simplify the user interactions. The system advantageously divides activities into tasks, and tasks into sub-tasks that are presented to the user one at a time in order to simplify the interaction. The system utilizes a dynamic text-to-speech technology in conjunction with pop-up windows in order to present simplified choices to the user one step at a time.

In one embodiment, the present invention relates to a software application installed on a computer-based device of the user. The software application serves as an overlay, thereby allowing the user to simply interact with the user interface of the software application in order to access various features and functions of the computer-based device. In a preferred embodiment, the computer-based device can be a portable electronic device such as a tablet computer or a smart phone. The software application can utilize various functions or features of the portable electronic device using an application programming interface (API).

In one aspect of the present invention, there is provided a computer-based method of guiding a user in operating a computer-based device including a processor, a memory, a display and a speaker. The method includes operating a software application having instructions for interacting with an operating system or software code stored in the memory using an application programming interface. The method further includes displaying a home screen having a first plurality of elements that include a plurality of buttons that are linked to a plurality of activities, respectively. A first script data is selected from a first plurality of script data sets associated with the home screen, the selection being based at least on the number of times the user previously visited the home screen. The method further includes receiving user data including at least one of an input by the user provided using the computer-based device or an input by a helper of the user provided using another computer-based device used by the helper. The method further includes receiving non-user data including at least one of a current date, time, or location. A first dialog is displayed as instructed by the first script data set and based on the user data and the non-user data. A first audio message is generated using the speaker. The method further includes modifying the display of at least one of the first plurality of elements of the home screen based on the first dialog and as instructed by the first script data.

In another aspect of the invention, a computer-based user assistance system is provided for assisting a user of a computer-based device. The system includes a memory for storing user data including at least one of an input by the user received using the computer-based device or an input by a helper of the user received from another computer-based device. The system includes a processor connected to the memory configured to operate a software application having instructions for interacting with an operating system or software code stored in the memory using an application programming interface. The system includes a display configured to display a home screen having a first plurality of elements that include a plurality of buttons that are linked to a plurality of activities, respectively. The system further includes a speaker for generating audio messages to the user. The processor is configured to select a first script data set from a first plurality of script data sets associated with the home screen, the first script data set having a plurality of sequential events. An event may have a duration field for specifying the duration of the corresponding event and a state specification for an element identifier corresponding to an element for modifying display of the element. The processor is further configured to sequentially execute the plurality of sequential events, wherein the executed events cause display of a dynamic dialog on the display and generation of an audio message based on the user data and the non-user data.

In certain embodiments, the processor advantageously utilizes artificial intelligence to output information that is deemed to be helpful for the user. The processor is further configured to draw inferences based on at least one of user data received regarding the user from the user and/or a helper of the user, or non-user data regarding for example, the current date, time, or weather conditions. The processor is configured to draw inferences based on the collected user data and non-user data in order to determine information that the user would be interested in receiving. The processor would take into account that the user has limited technical expertise and therefore determine contents of the information such that the outputted information and the requested inputs from the user would be easy to understand and follow for the user. The inferences drawn can further help determine the current interests of the user and redirect the flow of the user interface accordingly. The manner in which information is conveyed to the user can be modified to allow the user to easily follow the information and/or instructions for providing an input.

Thus, the present invention makes it possible to guide a non-technical user through various steps of an activity. An electronic host guides a user by outputting helpful information by displaying dialogs, outputting audio information, and modifying display elements.

The foregoing and other features and advantages of the present invention will become more apparent from the reading of the following detailed description of the invention in conjunction with the accompanying drawings.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a block diagram of a computer-based device utilized by a method/system according to an embodiment of the present invention;

FIG. 2 is a block diagram of certain software-based components of an embodiment of the method/system of the present invention, for accessing functions and features of the computer-based device of FIG. 1;

FIG. 3 is a block diagram showing software-based components of a user interface of a method/system according to an embodiment of the present invention;

FIG. 4 is a block diagram showing examples of the activities shown in FIG. 3 according to an embodiment of the present invention;

FIGS. 5A and 5B collectively show a flowchart diagram of a computer-based method of guiding a user in utilizing functions of a computer-based device, according to an embodiment of the present invention;

FIG. 6 is a block diagram showing software updates and user data inputs according to an embodiment of the present invention;

FIG. 7 is a screenshot of the user interface of a home activity according to an embodiment of the present invention;

FIG. 8 is a screenshot of the user interface of the home activity shown in FIG. 7 after display of certain elements is modified according to an embodiment of the present invention;

FIG. 9 is a screenshot of the user interface of the talk-and-contacts activity shown in FIG. 7, according to an embodiment of the present invention;

FIG. 10 is a screenshot of an email list screen of the email activity shown in FIG. 7, according to an embodiment of the present invention;

FIG. 11 is a screenshot of a reply screen of the email activity shown in FIG. 7, according to an embodiment of the present invention; and

FIG. 12 is a screenshot of the user interface of the photos/videos activity shown in FIG. 7, according to an embodiment of the present invention.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Preferred embodiments of the present invention will now be described in detail with reference to the accompanying drawings.

The present invention relates to a computer-based user guidance and assistance system and method. The system and method can be operated using a variety of computer-based devices including but not limited to stationary computers such as a desktop computer, or portable electronic devices such as a laptop, notebook, tablet computer, or smart phones. In a preferred embodiment, the system is implemented on a tablet computer such as an Apple iPad®. The system may be compatible with a variety of operating systems such as Android or iOS.

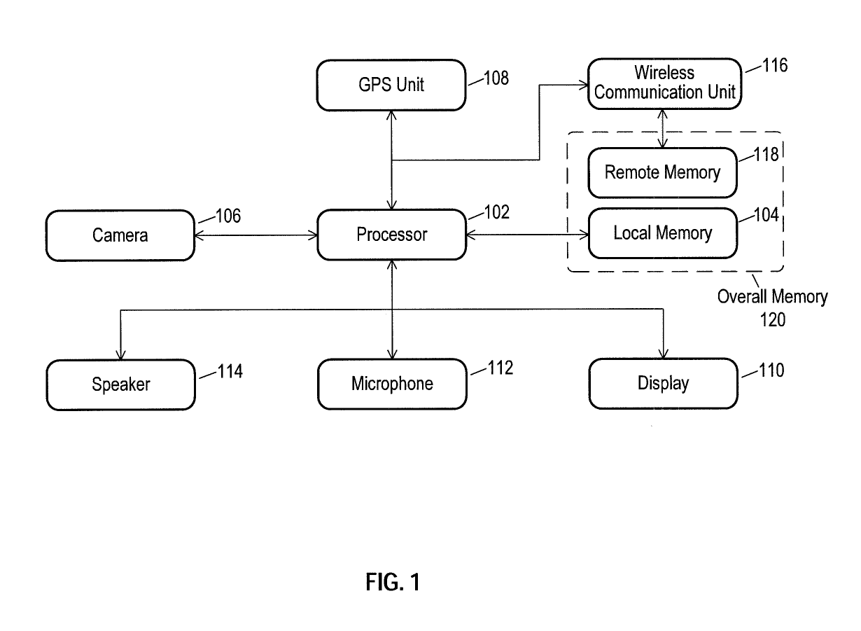

FIG. 1 shows a block diagram of some of the relevant components utilized by the invention. The computer-based guidance system 100 (“system 100”) utilizes a processor 102 connected to a local memory 104. In one embodiment, the processor 102 includes one or more central processing units (CPUs) of a computer-based device. The local memory 104 includes a memory of the computer-based device such as a flash semiconductor memory. Data can be retrieved from or stored in a remote memory 118 as well. The remote memory 118 includes remotely located memory accessed from a host server or another computer-based device via the wireless communication unit 116. The remote memory 118 includes cloud-based memory. The overall memory 120 as used herein refers to local and remote memories, collectively. In one embodiment, the software code for implementing the steps described herein is stored partially in the local memory 104 and partially in the remote memory 118. In other embodiments, the software code can be stored locally, and updated using data received from the remote memory 118 periodically or as needed otherwise.

The processor 102 is connected to a Global Positioning System (GPS) unit 108 for determining a current location of the computer-based device. A camera 106 is provided for capturing images and/or videos. In one embodiment, the camera 106 is a camera integrated in the computer-based device.

The processor 102 determines output data that can be conveyed to the user using a display 110 of the computer-based device. In one embodiment, the display 110 is a touch-screen display screen further configured to receive inputs from the user.

A speaker 114 is also provided for conveying audio information to the user. A microphone 112 is provided for capturing an audio input received from the user. The processor 102 is configured to parse and analyze detected audio data using a speech recognition algorithm.

The processor 102 is connected to a wireless communication unit 116 configured to establish wireless data communication between the computer-based device and the remote memory 118 or another remote server or computer-based device. The wireless communication unit 116 includes antennas, wireless transmitters/receivers and related encoding/decoding components. The processor 102 can retrieve data from the Internet and/or upload data using the wireless communication unit 116.

In a preferred embodiment, the units shown in FIG. 1 are integrated in a portable electronic device such as a tablet computer or a smart phone.

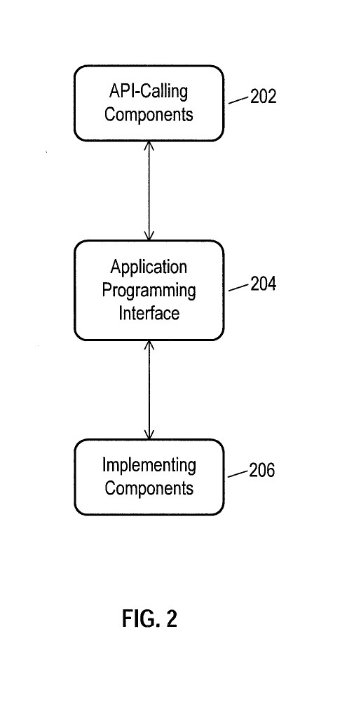

FIG. 2 is a block diagram of software components utilized by the present invention in order to access functions and features of a computer-based device using one or more Application Programming Interfaces (APIs) 202. An API 204 is an interface implemented by a program code component or hardware component (hereinafter “implementing components”) 206, which allows a program code component or hardware component (“API-calling components”) 202 to access and use one or more functions, methods, procedures, data structures, classes, and/or other services provided by the implementing component 206. An API 204 can define one or more parameters that are passed between the API-calling component 202 and the API-implementing component 206. “API-calling” does not refer to calling using a telecommunication feature. Rather, it refers to referencing an API 204 in order to utilize an implementing component 206 of the underlying operating system. Using the API model, the invention utilizes functions of the computer-based device such as telecommunications, texting, emailing, and/or various other functions in order to assist the user in utilizing the computer-based device. In other words, the user is able to seamlessly interface only with the user interface of the overlay software application of the present invention in order to utilize functions of the computer-based device.

In certain embodiments, the processor 102 advantageously utilizes artificial intelligence to output information that is deemed to be helpful for the user. The processor 102 is further configured to draw inferences based on at least one of user data received regarding the user from the user and/or a helper of the user, or non-user data regarding for example, the current date, time, or weather conditions. The processor is configured to parse and analyze the non-user data and/or user data. The processor is configured to draw inferences based on the collected user data and non-user data. The inferences allow the process to determine information that the user would be interested in receiving. The processor 102 would take into account that the user has limited technical expertise and therefore determine contents of the information such that the outputted information and the requested inputs from the user would be easy to understand and follow for the user. The information can be displayed and/or conveyed to the user via an audio message. The inferences drawn can further help determine the current interests of the user and redirect the flow of the user interface accordingly. The manner in which information is conveyed to the user can be modified to allow the user to easily follow the information and/or instructions for providing an input

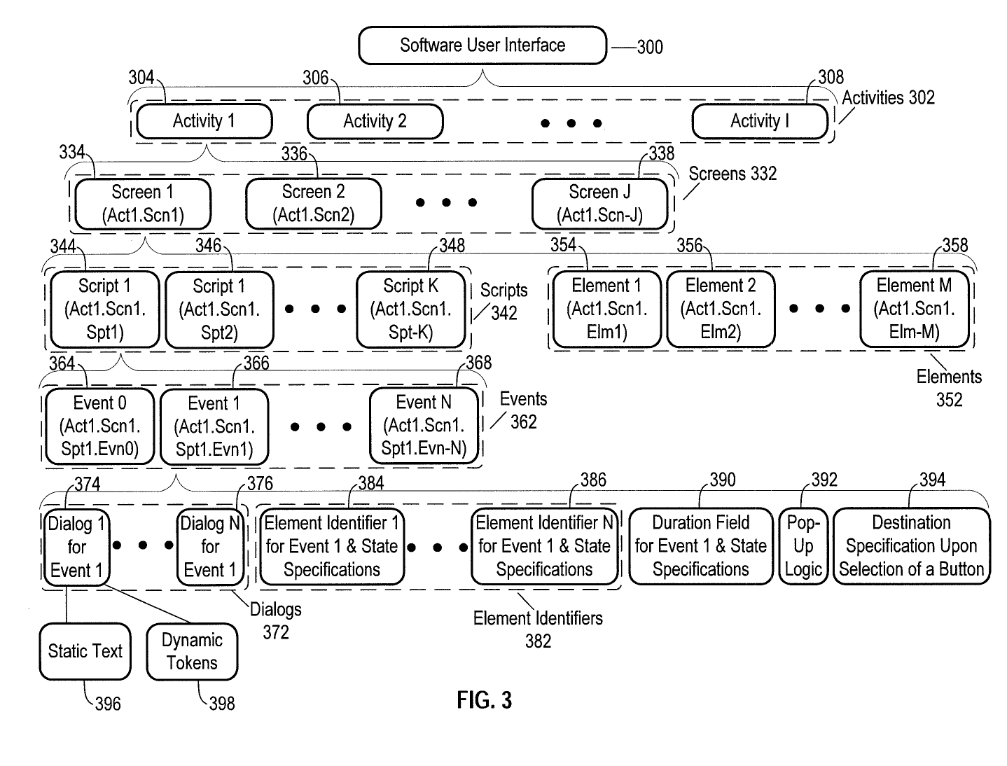

FIG. 3 is a block diagram showing software-based components of a user interface of a method/system according to an embodiment of the present invention. A software-based user interface (“interface”) 300 is provided for allowing the user of the computer-based device to interact with the computer-based guidance system 100. The interface 300 includes a limited number of predetermined activities 302. An activity as used herein refers to a grouping of functions performed by the computer-based device based in part on inputs provided by the user. An activity includes certain types of interactions between the computer-based device and the user. Each activity is managed by a custom program integrated with an electronic host for guiding the user through each step of the activity.

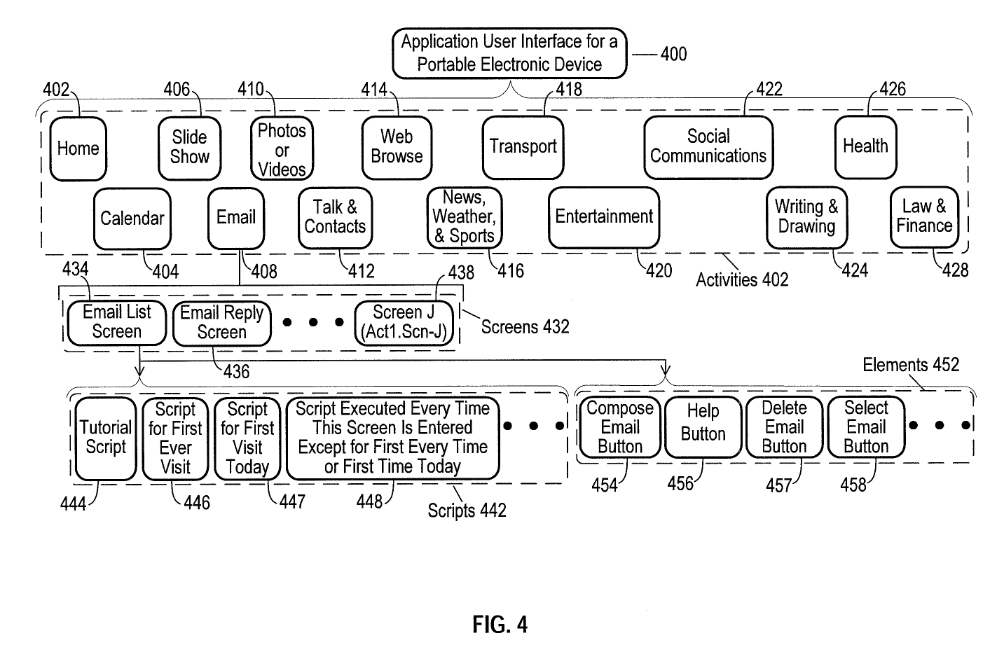

Examples of activities are described further below with respect to FIG. 4. The activities are listed as activity 1 (block 304), activity 2 (block 306), and . . . activity i (block 302). The ellipses indicate that there can be less or more activities can be provided based on design considerations and user needs. For example, one of the activities relates to sending/receiving emails and storing certain information of the received emails.

Referring to FIG. 3, each activity of the activities 302 has a plurality of screens, but for illustration purposes, only screens 332 of activity 1 (block 304) are shown. Screen 1 of activity 1 (block 334) is identified with the abbreviation of Act1.Scn1 to indicate that the screen corresponds to activity 1, and the same applies to screens in blocks 336 and 338. A screen displays dialogs and other information for the user in order to guide the user through each step of the activity. The processor 102 is configured to move from one screen of an activity to another screen of the activity, or alternatively, to a screen of a different activity based on user inputs and expected need of the user. The processor 102 also dynamically adjusts the screen during each step of the activity.

Every screen (332) is driven by one of several possible scripts at any given time. Scripts determine the information that is outputted to the user in text or speech. The scripts (342) also dictate modifications to the user interface. As the electronic host guides the user throughout the activity, screen elements can be modified, for example, to direct user's attention to certain elements. For example, if the electronic host outputs text and speech regarding use of a help button, the help button can be highlighted and/or enabled as discussed in further details below.

Although each screen includes a plurality of scripts, only scripts 342 of screen 1 (block 344) are shown in FIG. 3 for illustration purposes. A script corresponds to a set of codes or instructions for interacting with the user when a screen is displayed. A script allows the processor 102 to determine the voice and dialog outputted to the user based on data learned about the user and non-user data such as current date and time. The script allows the processor 102 to draw inferences based on the data, and output information to the user based on the inferences. The scripts are designed to render the interaction to be simple for the user, such that the user is guided throughout the operation of an activity. The script of a screen can dictate when the process stops operating the current script and starts operating the script of another screen.

The scripts 342 can be stored in the local memory 104. An advantage of storing locally is that the scripts can be uploaded faster. Alternatively, the scripts 342 can be stored in a remote memory 118, for example, on a remote server or in an online database such as Google Drive®. The scripts 342 can be uploaded periodically, upon user request. Alternatively, the scripts 342 can be updated as needed by the host server or an authorized user, based on design considerations.

Each screen includes a plurality of elements. Elements are discrete visual items on the screen that can take the form of buttons, information boxes, lists, or other items. The elements of the present invention are designed specifically for users with limited technical expertise. The elements are configured to convey information in an intuitive manner to the user. The elements can be buttons that offer intuitive choices for the user. The elements convey information and present step-by-step choices in order to prevent a user with a limited technical expertise from getting lost in the maze of alternatives present on most computer-based devices. The elements can be HTML-coded visual elements with simplified text and/or graphics for allowing the user to readily identify his/her choices.

For illustration purposes, only elements 352 of screen 1 of activity 1 are shown in FIG. 3. The elements include buttons which can have a defined destination or task to be performed upon selection by the user. The user may select a button by simply touching or tapping the displayed button. The button can change color upon selection by the user to provide feedback to the user that the button is being selected. The user may also select a button via a voice command. The processor 102 can recognize selection of a button via a speech recognition algorithm.

Different screens can have common buttons, but some screens have unique buttons. For example, in the contacts activity, an add-contact button is unique to that activity. However, a help button would be common to various activities. Elements can be displayed directly on the screen, or in a pop-up window that is displayed as an overlay on the screen.

The scripts 342 dictate modifications to display of elements 352. As the electronic host guides the user throughout the activity, screen elements 352 can be modified, for example, to direct user's attention to certain elements 352. For example, when the electronic host outputs text and speech regarding use of a help button, the help button can be highlighted and/or enabled as discussed in further details below.

Pop-up windows are dialog boxes that guide the user through a sub-task of an activity one step at a time. The pop-up window includes a text field or a button for receiving an input from the user. For example, composing an email is a task of an activity, and can be broken down to sub-tasks using an email, which comprises several steps (a. Choose type of email, b. Enter recipient name, c. Enter body of email, etc. . . . ). A pop-up window can be sequentially displayed for each of the subtasks, after an input for a sub-task is received. The pop-up window may display a question to the user, and the user may select an accept button or a cancel button to provide input accordingly. The system analyzes the inputs, and outputs helpful information to the user based on the inputs.

Scripts 342 include lists of events 362 that are executed in sequential order. Events 362 describe the change in state of any elements that need to change from a previous event. An event can also have a pop-up logic 392 for controlling the pop-up window, the message displayed in the pop-up window, and the input received by the pop-up window. An event can also redirect the flow of the user interface 300. For example, an event can direct the process to a different screen of the current activity or to a screen of a different activity. In certain embodiments, the events 362 advantageously utilize artificial intelligence to output information that is deemed to be helpful for the user. In certain embodiments, the process takes into account that the user has limited technical expertise and therefore the executed events 362 determine contents of the information such that they are easy to follow for the user. The events 362 also determine the displayed dialogs, the generated audio message, and/or modification of display elements such that the information is conveyed to the user in an intuitive manner. The events can further redirect the flow of the user interface based on the expected interests of the user.

For illustration purposes, only events 362 of script 1 of screen 1 of activity 1 are shown. Events 362 are sequentially numbered to indicate the order of operation. The events 362 are shown as starting from “0” simply by convention. The events 362 can alternatively start as 1 or any other sequential identification. Element states can be automatically set before event “0” in block 364 is executed. Event “0” (364) modifies and establishes the initial state of the screen before subsequent events (1, 2, . . . n) (in blocks 366 and 368) are executed. This includes specifying which elements (e.g., buttons) will be visual and/or active when the screen is initially displayed. Subsequent events (blocks 366 to 368) alter at least some of the initial states specified by event “0.” The events 362 may show, hide, disable, highlight, and/or perform various other functions with respect to the elements 352.

An event specifies a plurality of dialogs to be displayed either directly on the screen or on a pop-up window. For illustration purposes, only dialogs 372 for event 1 are shown. The dialogs may have static text 396 or dynamic tokens 398. The dynamic tokens 398 may be based on non-user data such as current date and time, and based on user data such as the name of the user, the birth date of the user, and other information known about the user.

One of the important features of the invention is its ability to personalize the user experience by including dynamic and relevant information when it interacts with the user. Information about the user is stored in a remote memory 118 and/or the local memory 104 database. When the data is stored remotely, the data can be transferred to the computer-based device of the user via a network connection. Scripts 342 can access this information using a dictionary of “tokens” that are integrated into the text of a script. The tokens 398 reference specific and dynamic pieces of information, such as the time of day, the user's name, or the user's daily horoscope. The tokens 398 allow the electronic host to establish a personalized relationship with the user, and provide helpful information and reminders based on data learned about the user.

Referring to FIG. 3, an event (block 362) has a duration field that indicates a pause value to apply after this event (block 390). Each event can have a duration field, but for illustration purposes, only the duration field for event 1 is shown. The duration field value (block 390) may correspond to certain number of seconds. Using the duration fields, the duration and timing of the events can be controlled.

The events 362 can include state specifications (block 382) in order to change the state of an element 352. An event can enable or disable an element, or render the element visible or invisible. When an element (352) such as a button is enabled, the user is able to click the element in order to operate the task corresponding to the button, or reach a destination corresponding to the element. An event (362) can highlight an element, for example, by displaying a blinking red border around the element. An event can brighten or dim the element. The foregoing changes to element status in addition to other changes can be utilized along with outputted dialog and audio information to guide the user during an activity. This advantageously directs attention to the relevant parts of the display in order to allow the user to understand functions of an activity or the response that is needed from the user.

Each event may further include a pop-up logic 392. This allows the event 362 to control the dialogs 372 displayed in the pop-up window of a screen, and the type of input requested from the user, as discussed above with respect to the scripts 342.

The destination of certain buttons can be specified by underlying logic of the software application, which may be modified by an event. An event can specify a destination for a button upon selection by a user, as shown in block 394. For example, the event can specify that the process shall navigate to a different screen of a current activity or a screen of a different activity upon selection of a button in the current screen.

An exemplary embodiment of the invention described with respect to FIG. 3 is described below. In the exemplary embodiment, the user interface 300 is a user interface of a software application installed or pre-configured on a computer-based portable electronic device such as a tablet computer. The software application serves as an overlaid operating system, which can access various existing features and functions of the computer-based device using APIs described above with respect to FIG. 2.

The scripts of each of the screens 332 can be stored as data sheets in data workbooks. Data workbooks and sheets may be stored in an online database that can be remotely accessed via the wireless communication unit 116. The script data can be shared in such a way that an authorized device running the software application can access them. The software application accesses these workbooks directly via a web address such as a uniform resource locator (URL). The software application loads the data dynamically as needed. With the foregoing approach, the spreadsheets become the live script database for the software application.

A benefit of the exemplary embodiment is that the scripts 342 can be easily modified, and the modifications can be instantly updated to all or selected devices running the software application. In other words, the behavior of the software application (e.g., the displayed messages, and outputted audio information) can be changed in real-time.

In the exemplary embodiment, each screen has a corresponding workbook having multiple spreadsheets, with each spreadsheet including a script data set. Screen paths can be mapped to the addresses of script workbooks for each screen. The mapping data can be stored in a table of contents data sheet, thereby mapping each screen of an activity to a given URL address associated with the screen. The table of contents data sheets allow the software application to easily locate the script files.

The script workbook includes an element sheet containing the screen's element. The events can specify dialogs, element identifiers, duration fields, pop-up logic, destinations for buttons, and/or various other changes to configurations as discussed above with respect to events 362.

Each screen may have a plurality of possible scripts in order to customize the user experience based on an expectation of what information the user would be interested. The screen can be selected based on at least the number of times the user has previously utilized an activity. This allows the host to provide more information during first visits, and avoid overly repetitive output information during subsequent visits. For example, a script can be utilized for the first time the home screen is visited each day, and a different script can be utilized for subsequent visits during the same day.

Elements data sheets are provided for listing element identifiers 382 of the current screens. Elements 352 include buttons, and other discrete items on the screen that can be modified by the events. Buttons can be mapped to a task/function to be performed upon selection of the button. Examples of elements 352 that are not buttons are a list of emails, and the information header at the top of the screen. When the displayed dialog 372 relates to an element, the event can highlight or draw a box around the element to direct the user's attention to the element.

In the exemplary embodiment, the scripts 342 include tokens 398 entered directly into the script text. The token values can correspond to non-user data such as time of day, current clock time, temperature, and various other data that is not particular to the user. The values of the token 398 can correspond to user data such as the first name of the user, the last name of the user, birth place/date of the user, home state of the user, the name of a user's helper and the helper's relationship with the user, the name of a user's relative, the gender of the user/helper, possessive pronoun (her/his), astrological sign of the user, astrological description, and/or various other information learned about the user. For example, “Hello Bill, it is now 1:35 p.m. in the afternoon and 72 degrees outside,” requires the following three dynamic pieces of information: 1) the user's name, 2) the clock time, and 3) the time of day (morning, afternoon, or evening). The actual sentence created by the scripter would refer to: “Hello &FN, it is now &CT in the &TD and &TP degrees outside.” The tokens 398 of &FN, &CT, &T, and &TP can be filled in by the processor 102 based on user data and non-user data.

Some token values, such as the user's name, are loaded when the app first launches. Other tokens, such as the current clock time, are updated in real time. Some tokens 398 are updated every time a screen is entered. For example, specific information about the current email such as its sender and subject line can be set every time the screen is entered. The tokens 398 can correspond to values corresponding to the screen of an activity such as the current email subject text, current email sender, current email recipient, current unviewed email count, and various other values. The process can utilize the information to proactively and dynamically output helpful information about the screen. In the foregoing example, the host can output text and audio information about recent emails by utilizing tokens related to the email list.

FIG. 4 shows an exemplary embodiment described with respect to FIG. 3. In this embodiment, the system of the present invention is implemented for a portable electronic device of a user such as a tablet computer. The application user interface 400 includes activities 402. An overall description of each of the exemplary activities is provided below.

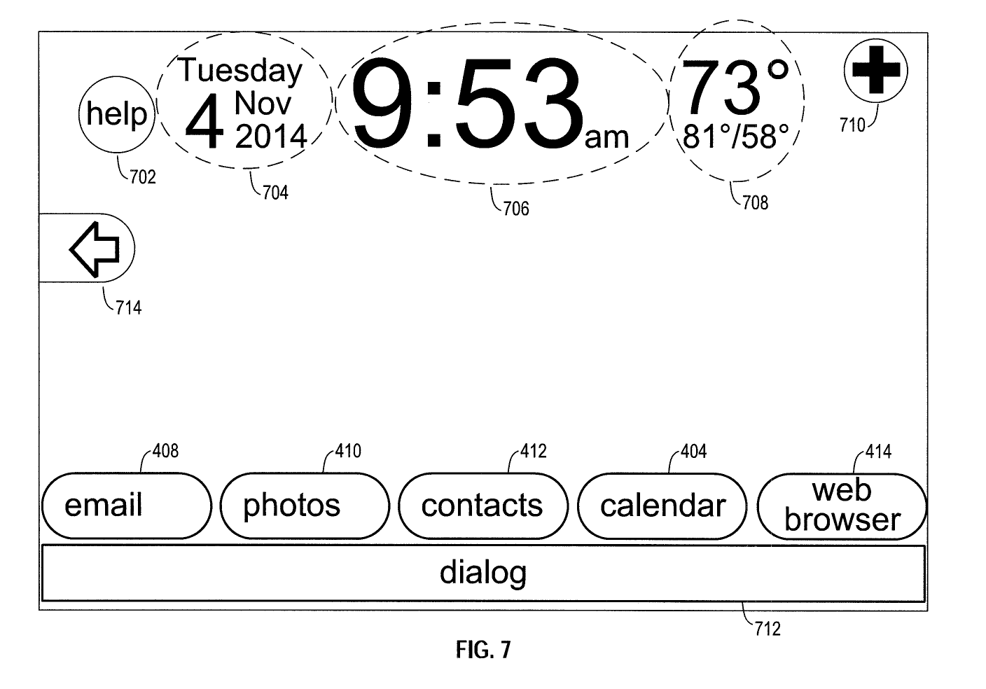

A home activity 403 is the first screen that is operated upon initial use of the software application. FIG. 7 shows an example of a user interface screen of the home activity. The home screen displays a list of activities available to the user such as an email activity 408, photos/videos activity 410, contacts activity 412, calendar activity 404, web browse activity 414, and/or additional activities. The home screen displays current date, day of the week time, time, and temperature, as shown in 704, 706, and 708.

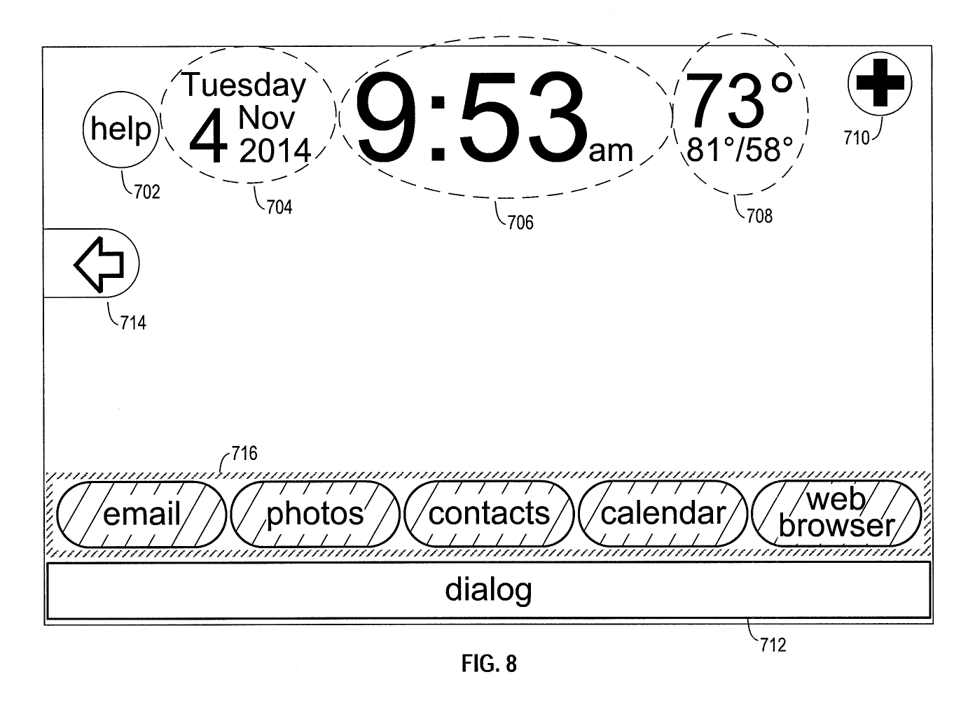

Referring to FIG. 8, a dialog box 712 is provided for outputting a dynamic dialog to the user. As the text in the dialog box 712 is displayed, audio information can be provided using text-to-speech technology. The dialog lists words of a sentence in sequence as they are pronounced using speech outputted by the speaker in order to allow the user to easily follow the outputted information. The display can be modified as the text appears. For example, when the text relates to the activities, a boundary 716 in a different color can be drawn around the activities in order to direct the user's attention to the activities, as shown in FIG. 8. The activities can also be highlighted in a different color (for example, in yellow) in order to direct the user's attention to the activities, as indicated by the shaded area.

Referring back to FIG. 7, the home activity 403 includes a help button 702. Upon selection of the help button 702, the system can provide personal help regarding issues related to the home activity 403. The help button 702 can be included in each activity to allow the user to seek help specific to the current activity. Upon selection of the help button 702, the script data dictates the information that is outputted to the user. The outputted information can be conveyed to the user via the dialog text 712, pop-up windows, audio/video message, and/or other means. In the home activity 403, the information introduces the user to various functions/features of the software application. The information also utilized data learned about the user to personalize the message. For example, the host may call the user by his/her name, and inform him/her about the activities (e.g., email 408, photos/videos 410, talk-and-contacts 412, and/or other activities) that are available to the user.

All activities, including the home activity, include an emergency button 710. Upon selection of the emergency button 710, a helper of the user or an urgent care associate can be contacted to establish a real time audio/video communication. Upon selection of the emergency button 710, an alarm can be played using the speaker 114 to alert surrounding persons. Furthermore, audio/video communication with an operator of an emergency call center can be established. Audio/video communication functions of the computer-based device can be an implementing component 206 discussed above with respect to FIG. 2. The software application can utilize the audio/video communication features of the computer-based device using the API 204. The host can use user data and current information to communicate with a 911 operator. Other tasks as specified by user or a helper of the user can be operated upon selection of the emergency button 710.

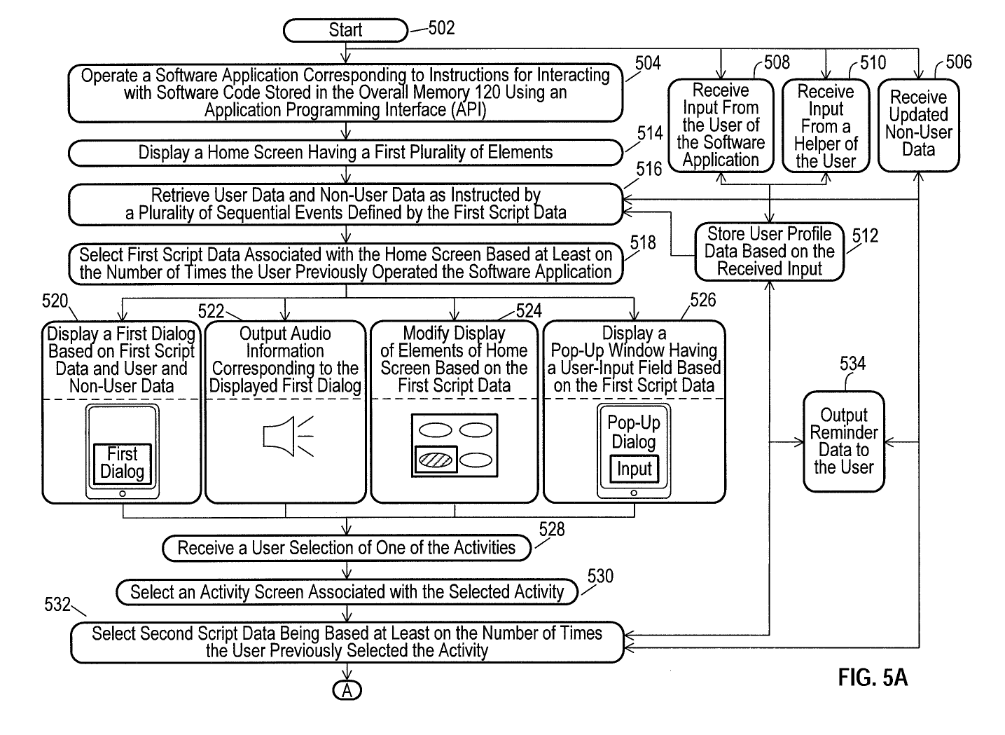

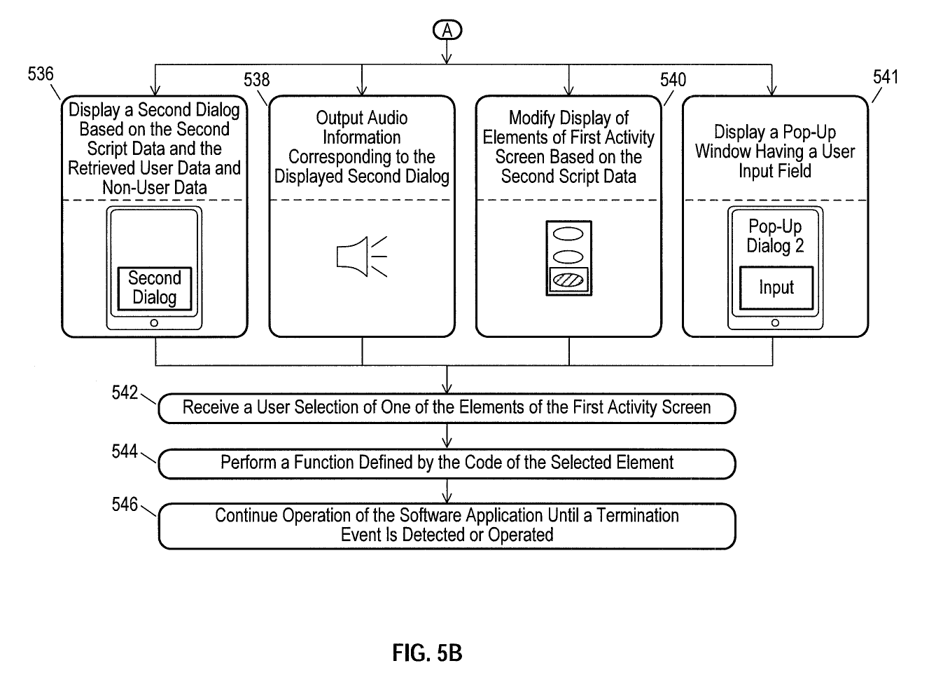

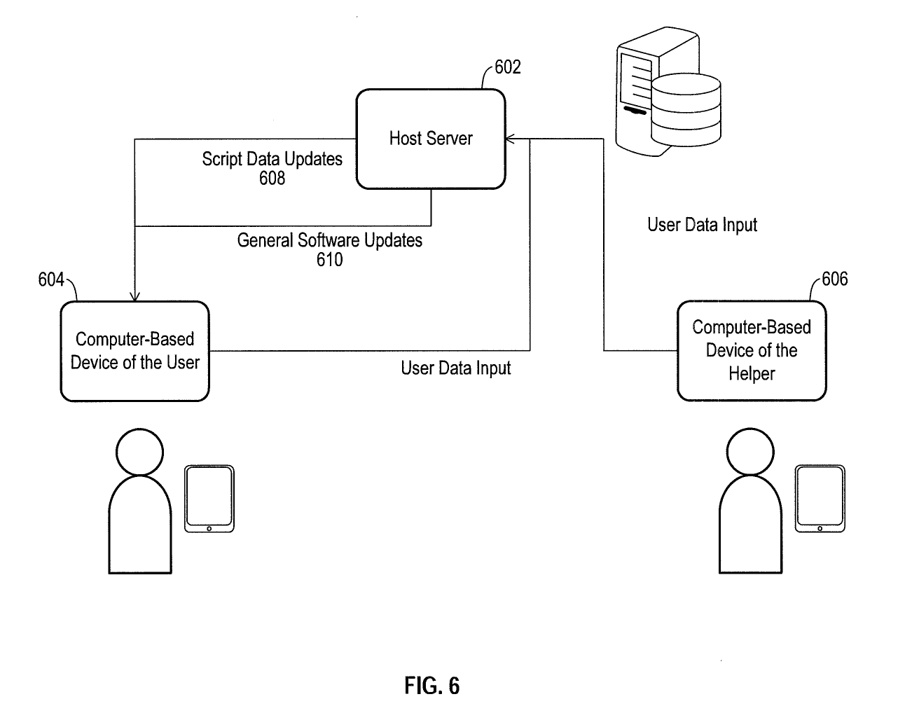

Referring to FIGS. 4 and 7, a calendar activity 404 is provided. With the guidance of the electronic host, the user can create calendar events. The inputs for the calendar events are requested from the user step-by-step in order to simplify data entry. As discussed in further details below with respect to FIGS. 5A, 5B, and 6, calendar events are part of user data that can be received from the user and/or the helper. For example, medication reminders can be set as recurring reminders by the helper and/or the user. The processor 102 is configured to output reminder data to the user via the display 110 and/or the speaker 114.

Referring to FIG. 4, a slide show activity 406 is provided for displaying photos stored in the overall memory 120 as a slide show. The process may move to the slide show activity 406 upon request by the user or after no input is received after an idle time period. The default idle time period can be modified by the user and/or the helper.

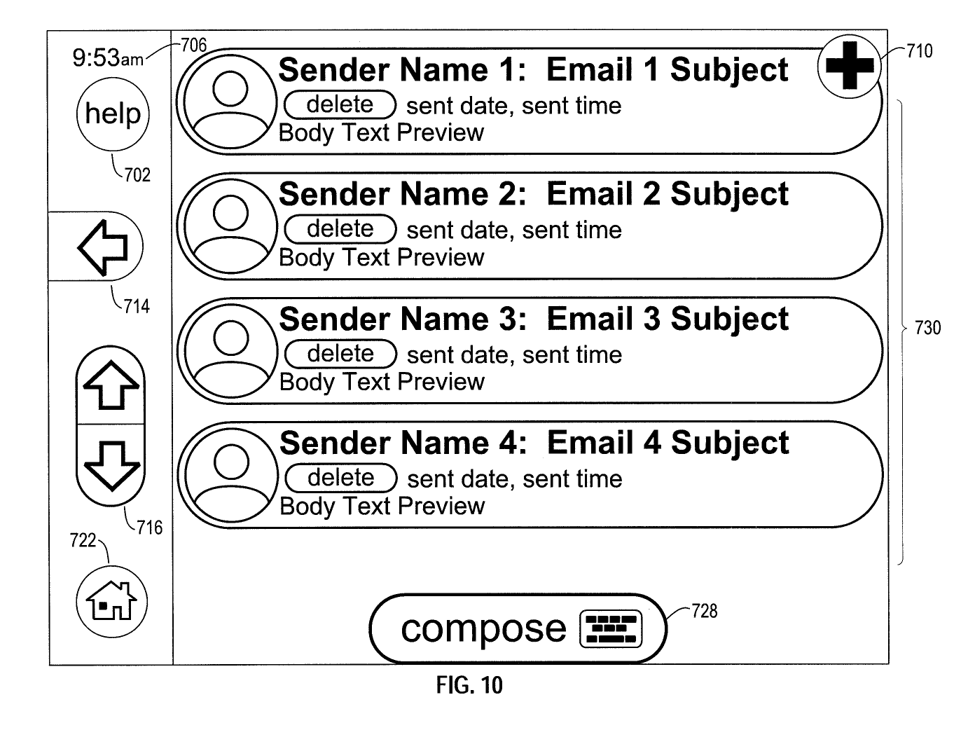

Referring to FIGS. 4 and 10, an email activity 408 is provided for guiding a user in receiving and sending emails. The user is guided with displayed dialog and voice output. The email functions are simplified to guide a user with a limited technical understanding. The host explains inputs that are needed, and requests the inputs step-by-step to simplify the tasks related to email receiving and sending. As can be seen in the email list screen show in FIG. 10, the text, graphics, type of input, and the number of needed inputs are simplified. The user can compose an email by touching the compose button 728. The user can scroll through the emails using scroll buttons 717. The emails are listed as shown in 730 in an intuitive format.

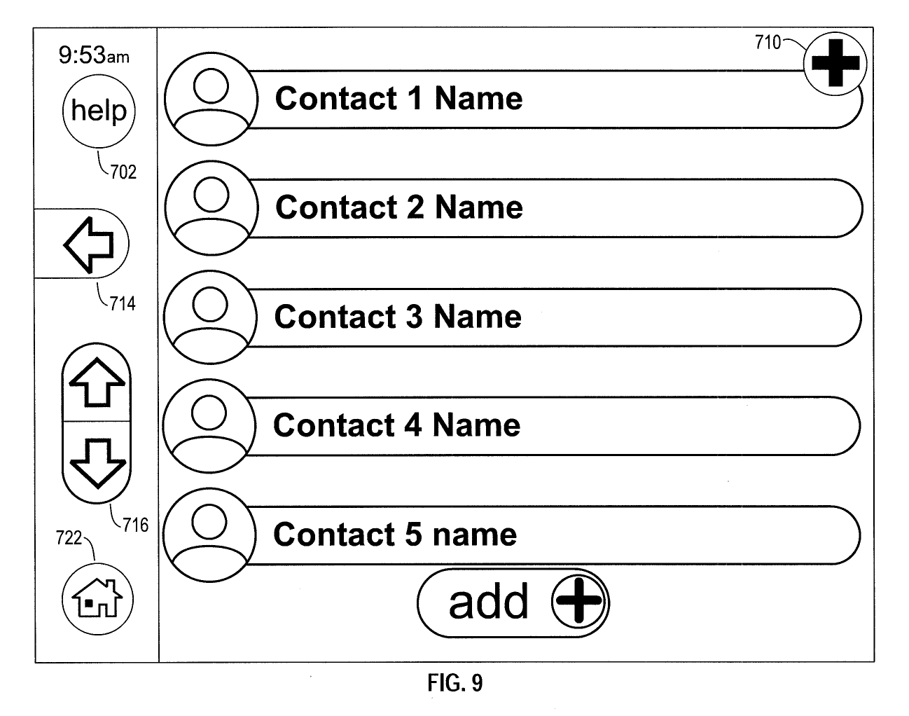

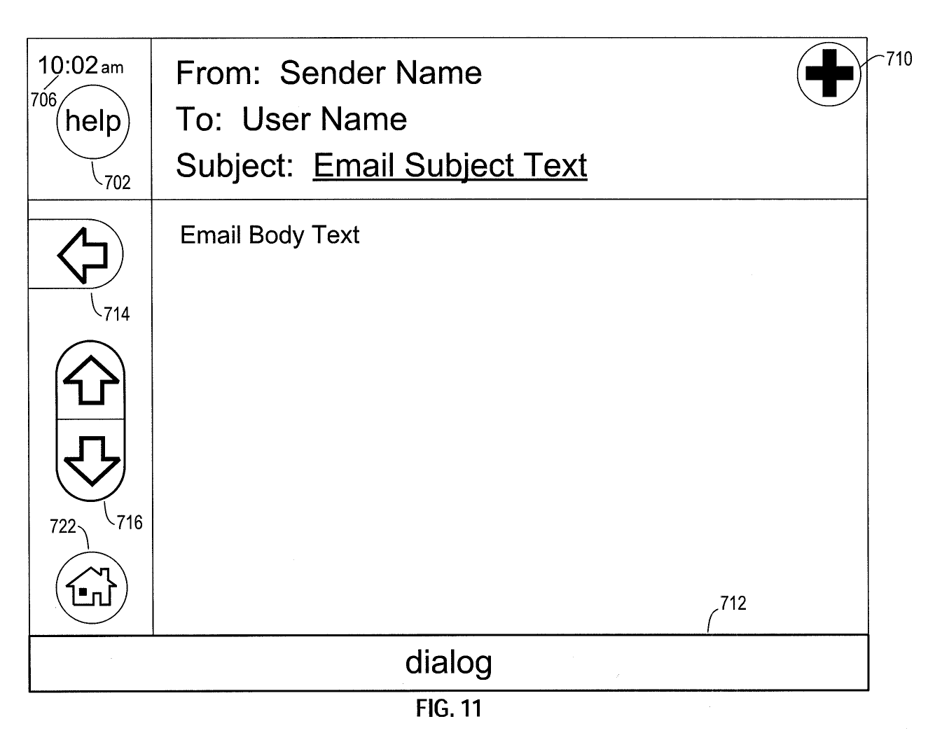

Referring to FIG. 11, the screen shows the body text of an email after the user selects a given email. The user has the option to listen to the host read the email. The processor 102 is configured to detect and parse data from the email. For example, the processor 102 is configured to detect the name of the sender (including use of reference to the contacts lists shown in FIG. 9). The host further detects the body of the email, which can be read to the user automatically or upon request.

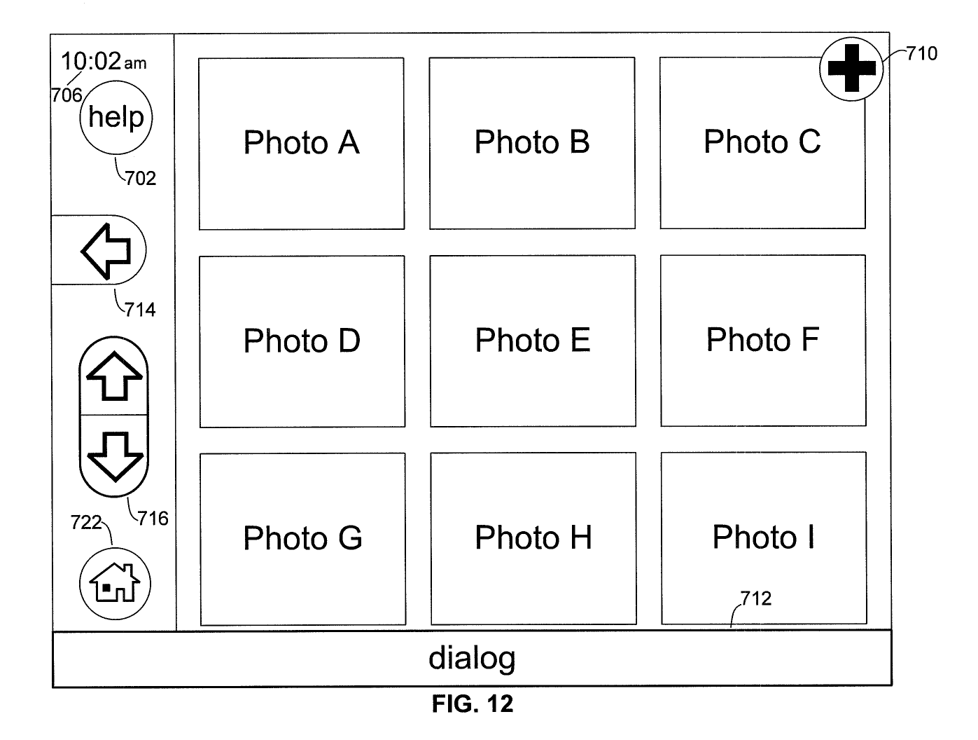

Referring to FIGS. 4 and 12, a photos/videos 410 activity is provided for guiding a user in viewing, editing, sharing photos or videos. The helper can also be provided access to the photos or videos, under the configuration shown in FIG. 6. The helper and/or the user can add, modify, and/or delete photos or videos. The stored photos/videos include photos/videos captured using the camera 106 of the computer-based device, and/or photos/videos received via email, web browsing, and/or social network sharing. The user can select one of photos A-I to modify, delete or share the selected photos.

Referring to FIGS. 4 and 9, a talk-and-contacts activity 412 is provided. In the first exemplary embodiment, the software application is configured to utilize audio/video communication functions of the computer-based device. As shown in FIG. 9, contact information is listed using simplified text. The user can tap the touch-screen display to select a contact, and dial the associated number. The contact information corresponds to user data entered by the user and/or the helper as shown in FIG. 6. In the talk-and-contacts activity 412, the user can dial or speak a number to establish an audio/video connection with the contacts. In the talk-and-contacts activity, the host guides the user in storing contacts from received emails. The user can add, delete, or edit contacts using simplified buttons, such as the add button, and scroll buttons shown in FIG. 9.

Referring back to FIG. 4, a web browser activity 414 is provided for guiding the user in browsing the Internet. A set of pre-determined choices for websites may be provided to the user to simplify web browsing. The user may also enter search terms directly. The processor 102 can parse speech of the user detected by the microphone 112 to detect terms of an Internet search. In one embodiment, the search terms and Internet history are monitored for advertising purposes.

Referring back to FIG. 4, a news, weather, and sports activity 416 is provided. This activity allows the user to choose from preselected news databases. The system uses the appropriate input to initiate response by the target source. Other sources can be selected and added by user choice or by input provided by the helper. Collection of data from the user and the helper are discussed below in further details with respect to FIGS. 5A, 5B, and 6.

Referring back to FIG. 4, a transport activity 418 provides information on local transportation options such as taxi, hire car, limo, bus, train, metro, etc. An entertainment activity 420 is provided for allowing the user to access e-books, games, movies, music, TV/radio shows, and/or other sources. The list of sources can be predetermined in part. The user and/or the helper can modify the list. A social connections activity 422 is provided for allowing the user to network with friends in order to share emails, documents, photos/videos, etc. The social connections activity 422 can be connected to external social network websites such as Twitter® or Facebook®.

A writing/drawing activity 424 can be provided to allow the user to read, create, and/or modify documents. Documents can be modified by touch-screen input. For example, the user can select icons or use freehand options to modify a document or drawing.

A health activity 426 is provided for allowing the user to establish connections with doctors, hospitals, pharmacists, and other medical facilities. An audio/video connection can be established between the computer-based device of the user and a computer-based device of a health care provider via the wireless communication unit 116. The health activity 426 provides health information from medical website based on inputs received regarding medical conditions or records of the user. Such inputs can be provided by the user and/or the helper of the user, as discussed in further details below with respect to FIGS. 5A, 5B, and 6. Medical records of user can be sent via a secured communication link to authorized medical care providers. Health evaluations can be performed in the health activity 426 based on the data inputted by the user and/or the helper. The system can be synced with a medical evaluation device having a sensor for detecting data regarding medical condition of a user such as pulse rate. Health evaluations can further be based on the detected data and user input data. Based on the collected data, the system can output helpful medical reminders, medical evaluations, and other information to the user.

A law and finance activity 428 is provided for allowing the user to access financial news, legal help websites, and/or other financial and legal online services and information. The system can establish an audio/video connection between the user and a financial advisor or attorney.

In each of the activities described above, the system can collect data of the user to provide targeted advertising based on user's needs. Online advertising can be shown on any screen of the activities. The advertising may relate to current events and need of the user. Advertisement information can be conveyed to the user by audio messages, video, displayed text/dialog, or any other method of communication. The host may utilize outputted voice or text to present advertisement information to the user. In one embodiment, the user can set the type of data that can be used for advertising purposes.

Each activity shown in FIG. 4 can be operated based on the process described below with respect to FIGS. 5A and 5B. FIGS. 5A and 5B show a flowchart diagram of an operation of the computer-based guidance system 100, according to an embodiment of the invention. In block 504, the processor 102 operates a software application corresponding to instructions for interacting with software code stored in the overall memory 120 and/or otherwise retrieved from the web. This can be performed using the API components described above with respect to FIG. 2. API-calling components 202 utilize implementing components 206 via an API 204 to assist and guide the user throughout each activity.

Blocks 506, 508, 510, and 512 correspond to obtaining user data and non-user data. Blocks 506, 508, 510, and 512 are not necessarily performed in the order shown in FIG. 5A. The user and non-user data can be retrieved and/or updated at any time, when or before the information is needed. In block 506, updated non-user data are received. The non-user data include data that are not specific to the user of the portable electronic device. The non-user data include current time, location, weather conditions, and/or other information that is not personal to the user. In block 508, data is received from the user of the software application. Data about the user can also be received from a helper of the user as shown in block 510. In block 512, the user profile data is stored based on the collected data. An exemplary embodiment of receiving and updating user profile data based on inputs of the user and/or inputs provided by a helper is described below in further details with respect to FIG. 6.

Throughout the use of the software application, and/or when the application is not being used, the user can receive reminders, as shown in block 534. The processor 102 is configured to draw inferences based on the user data and non-user data, and output helpful reminders to the user. For example, if the helper of the user or the user has previously provided a medication schedule, the processor 102 can output reminders based on the current time and other information learned about the user.

In block 514, a home screen is displayed, which has a first plurality of elements. A subset of the elements includes icons or buttons associated with the home activity. In block 516, the processor 102 selects first script data from a plurality of script data associated with the home screen. The selection can be based at least on the number of times the user previously operated the software application. As described above with respect to FIG. 3, the amount and type of outputted information are based on the expected preference of the user. During the first time the user visits a screen, a comprehensive explanation of the activities is provided because the user would expect additional guidance with respect to different functions of the screen as compared with the subsequent visits.

In block 516, user data and non-user data are retrieved as instructed by a plurality of sequential events defined by the first script data. In block 518, the events are successively operated as discussed above with respect to block 362 of FIG. 3.

The first script data for the home screen and corresponding sequential events dictate whether and how blocks 520, 522, 524, and/or 526 are performed. In block 520, a first dialog is displayed based on the first script data and the retrieved user and non-user data, as shown for example in dialog 712 of FIG. 7.

In block 522, audio information is outputted using the speaker 114. The audio information may correspond to the displayed first dialog using a text-to-speech algorithm. The computer-based system may be pre-configured with a text-to-speech dictionary. The pre-configured dictionary includes certain pronunciations. The system of the present invention has the advantage of supplementing the pre-configured dictionary using a dictionary supplement stored in the local memory 104 and/or the remote memory 118. The supplement dictionary can provide pronunciations that would supplement or override the pronunciations stored in the pre-configured dictionary. For example, the supplement dictionary would indicate that the numbers of “911” would be pronounced as “nine-one-one” instead of “nine hundred and eleven.” This pronunciation would take precedence over the default dictionary when “911” is pronounced in a speech directed to the user.

In block 524, display of elements of the home screen is modified based on the displayed dialogs and/or outputted audio information. For example, when a particular element is being described in blocks 520 and/or 524, the element can be highlighted. Other functions can be performed on the elements as discussed above with respect to FIG. 3. In block 526, a pop-up window with a user-input field and a second dialog is displayed. The pop-up logic was described above with respect to blocks 342 and 392 of FIG. 3.

Upon a user selection of a particular activity in block 528, the processor 102 selects an activity screen associated with the selected activity. The processor 102 selects a second script data from a plurality of script data associated with the selected activity screen. The selection is based at least on the number of times the user previously selected the activity.

Upon receiving a user selection of one of the activities in block 528, an activity screen is selected in block 530. In block 532, the processor 102 selects second script data from a plurality of script data associated with the selected activity screen. The selection can be based at least on the number of times the user previously selected the activity. As described above with respect to FIG. 4, the process is mindful of the amount and type of information that the user would be interested in. During the first time that a user visits a screen, the user would expect additional guidance with respect to different functions of the activity as compared with the subsequent visits.

In block 536, a second dialog is displayed based on second script data and the received user data and non-user data. For example, if the selected screen is an email list screen, the second dialog corresponds to the newly received emails and/or whether the user is interested in responding to the emails. In block 538, audio information is outputted using the speaker 114. The information corresponds to the displayed second dialog. In block 540, display of elements of the home screen is modified based on the displayed dialogs. For example, when a particular email is being described in block 536, the email can be highlighted.

In block 541, a pop-up window with a user-input field and a second dialog is displayed. The pop-up logic was described above with respect to blocks 342 and 392 of FIG. 3. In block 542, a user selection of one of the elements of the first activity screen is received. The element may be a button with a specified function. For example, the compose button 728 in FIG. 10 corresponds to a compose email function. In block 544, a function defined by the code of the selected element (e.g., button) is performed.

The system advantageously guides the user in using various functions of the device by presenting inputs or response choices in a simple step-by-step fashion. In one embodiment, only those choices necessary for the next step are displayed to eliminate confusion. The user can set which form of inputs are preferred including, where appropriate: touch, click, swipe, multi-finger touch or swipe, gestures, image recognition, voice, sound, movement of the device, and other methods.

As shown in block 546, the operation of the software application continues until a termination event. The termination event may be a user request to terminate the software application temporarily or permanently. If no termination event is detected, the process navigates through different screens of activities based on user inputs, similarly to the process described above with respect to blocks 504-544.

FIG. 6 is a block diagram showing software updates and user data inputs according to an embodiment of the present invention. The host server 602 stores user data, which can be inputted by a computer-based device 604 of the user and/or the computer-based device 606 of the helper of the user. A helper as used herein refers to a relative, loved one, friend, caretaker, assistant, advisor, a trusted associate, and/or any other person with authorized access to provide user data. The helper can log into a website connected with the host server 602 to provide user data. The user profile and preferences can be defined and updated based on data provided by the user and/or the helper. The user data can include other information such as health factors, contacts, calendars, preferences, reminders, financial information, and various other types of information regarding the user. The user data can be utilized to personalize the interactions between the electronic host and the user, and to provide helpful information based on the user data as set forth above with respect to FIGS. 3, 5A, and 5B. For example, the user and/or the helper can provide information regarding a medication schedule. The system can output reminders based on the user data. The user data can be stored in the local memory 104 and/or the remote memory 118.

The application software code can be stored locally, and updated using script data updates 608 received from the remote memory 118 periodically or as needed otherwise. This advantageously allows the scripts 342 to be updated without re-installing, re-configuring, or updating the overall software application. This allows software developers to modify the behavior of the method/system and update all connected computer-based systems instantaneously. For example, the behavior can be changed in terms of the dialog or speech that is outputted, pop-up windows, and/or various other features of the system that are dictated by the scripts as described above with respect to FIGS. 3, 4, 5A, and 5B. In addition, if the overall software needs an update, general software updates data 610 can be transmitted from the host server 602 to the computer-based device 604. The processor 102 would utilize the general software updates data 610 to update the software of the computer-based device 604. As such, the method shown in FIG. 6 advantageously allows the host server 602 to selectively update parts of the software application installed on the computer-based systems of the users instantaneously.

As set forth in the embodiments described above, the integrated host advantageously guides a user in an intuitive fashion through various available activities. The foregoing embodiments and variations may be appropriately combined either partially or wholly. While only certain presently preferred embodiments of the present invention have been described in detail, as will be apparent to those skilled in the art, certain changes and modifications may be made in embodiment without departing from the spirit and scope of the present invention as defined by the following claims.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A computer-based method of guiding a user in operating a computer-based device including a processor, a memory, a display and a speaker, the method comprising:
operating a software application having instructions for interacting with an operating system or software code stored in the memory using an application programming interface;
displaying a screen having a first plurality of elements;
selecting a first script data set from a first plurality of script data sets associated with the screen, the selection being based at least on the number of times the user previously visited the screen;
receiving user data including at least one of an input provided by the user using the computer-based device or an input provided by a helper of the user using another computer-based device used by the helper;
outputting information to the user by performing at least one of displaying a first dialog or generating a first audio message using the speaker, as instructed by the first script data set and based on at least the user data; and
modifying display of at least one of the first plurality of elements of the screen based on the first dialog and as instructed by the first script data set.

2. The method of claim 1, wherein the first script data set defines a plurality of sequential events, each of the plurality of sequential events having a duration field and a state specification for an element identifier corresponding to at least one of the first plurality of elements.

3. The method of claim 2, wherein the first plurality of elements include a first plurality of buttons that are linked to a plurality of activities, respectively, the method further comprising:
receiving non-user data including at least one of a current date, time, or location;
sequentially executing the plurality of sequential events using the processor, wherein the first dialog, the first audio message, and the modification of the display of the at least one of the first plurality of elements are determined by the executed plurality of sequential events and are based on the user data and the non-user data.

4. The method of claim 1, further comprising:
receiving a user selection of one of the first plurality of buttons that is associated with a first activity;
selecting an activity screen associated with the first activity, the activity screen having a second plurality of elements that include a second plurality of buttons;
selecting a second script data set from a second plurality of script data sets associated with the first activity based on at least the number of times the user previously selected the first activity;
displaying a second dialog as instructed by the second script data set and based on the user data; and
generating a second audio message as instructed by the second script data set and based on the user data.

5. The method of claim 4, further comprising the steps of:
receiving a user selection of a button of the activity screen; and
performing a function associated with the selected button.

6. The method of claim 1, further comprising:
establishing a connection with an email server of the user based on the user data;
displaying a second dialog describing buttons that can be used to view, listen to, or send emails;
displaying a third dialog based on contents of emails received from the email server; and
generating audio messages using the speaker based on contents of the emails received from the email server.

7. The method of claim 1, wherein the step of receiving the user data includes receiving data entries of the helper of the user on a website after the helper logs onto the website.

8. The method of claim 1, wherein the computer-based device is a portable electronic device, the display is a touch-screen display screen of the portable electronic device, and the memory includes a local memory of the computer-based device and a remotely located memory.

9. The method of claim 1, further comprising automatically updating the first plurality of script data sets by transmitting script update data from a host server to the computer-based device without re-installing the software application.

10. A computer-based method of assisting a user in operating a computer-based device including a processor, a memory, a display and a speaker, the method comprising:
operating a software application having instructions for interacting with an operating system or software code stored in the memory using an application programming interface;
receiving user data including at least one of an input provided by the user using the computer-based device or an input provided by a helper of the user using another computer-based device used by the helper;
displaying a home screen having a first plurality of elements that include a first plurality of buttons that are linked to a plurality of activities, respectively;
selecting a first script data set from a first plurality of script data sets associated with the home screen, the first script data set having a plurality of events, at least one of the events having a duration field and a state specification for an element identifier corresponding to at least one of the first plurality of elements; and
executing the plurality of events in a sequential order, wherein the executed plurality of events cause display of a dynamic dialog and generation of an audio message from the speaker based on the user data.

11. The computer-based method of claim 10, the step of selecting the first script data set is based at least on the number of times the user previously visited the home screen.

12. The computer-based method of claim 10, further comprising modifying display of the first plurality of elements as instructed by the plurality of events.

13. The computer-based method of claim 10, further comprising:
receiving a user selection of one of the first plurality of buttons that is associated with a first activity;
selecting an activity screen associated with the first activity, the activity screen having a second plurality of elements that include at least one button;
selecting a second script data set from a second plurality of script data sets associated with the first activity based on at least the number of times the user previously selected the first activity;
receiving non-user data including at least one of a current date, time, or location;
displaying a second dialog as instructed by the second script data set and based on the user data and the non-user data; and
generating a second audio message as instructed by the second script data set and based on the user data and the non-user data.

14. The computer-based method of claim 13, wherein the second script data set has a second plurality of sequential events, at least one of the second plurality of sequential events having a pop-up logic for displaying a pop-up window having a user-input field.

15. A computer-based user assistance system for assisting a user of a computer-based device, comprising:
a memory for storing user data including at least one of an input provided by the user received using the computer-based device or an input provided by a helper of the user using another computer-based device;
a processor connected to the memory and configured to operate a software application having instructions for interacting with an operating system or software code stored in the memory using an application programming interface;
a display configured to display a home screen having a first plurality of elements that include a first plurality of buttons that are linked to a plurality of activities, respectively; and
a speaker for generating audio messages to the user,
wherein the processor is configured to perform the following steps:
selecting a first script data set from a first plurality of script data sets associated with the home screen, the first script data set having a plurality of sequential events, each of the plurality of sequential events having a duration field for specifying a duration of a corresponding event and a state specification for an element identifier corresponding to an element for modifying display of the element, and
sequentially executing the plurality of sequential events, wherein the executed plurality of sequential events cause at least one of display of a dynamic dialog on the display or generation of an audio message based on the user data.

16. The computer-based user assistance system of claim 15, wherein the processor is further configured to perform the following steps:
receiving a user selection of one of a second plurality of buttons associated with a first activity,
selecting an activity screen associated with the first activity, the activity screen having a second plurality of elements that include at least one button,
selecting a second script data set from a second plurality of script data sets associated with the first activity based on at least the number of times the user previously selected the first activity,
receiving non-user data including at least one of a current date, time, or location;
displaying a second dialog as instructed by the second script data set and based on the user data and non-user data, and
generating a second audio message as instructed by the second script data set and based on the user data and non-user data.

17. The computer-based user assistance system of claim 16, wherein the second script data set has a second plurality of sequential events, at least one of the second plurality of sequential events having a pop-up logic for displaying a pop-up window having a user-input field

18. The computer-based user assistance system of claim 15, wherein the plurality of activities include an email activity for establishing a connection with an email server of the user based on the user data, and for displaying dialogs and generating audio messages based on contents of one or more received emails.

19. The computer-based user assistance system of claim 15, further comprising a wireless communication unit including an antenna for establishing data communication with a remotely located computer-based device, wherein the memory includes a local memory of the computer-based device and a remotely located memory that can be accessed via the wireless communication unit.

20. The computer-based user assistance system of claim 15, wherein the plurality of activities include a photos and videos activity for viewing, saving, or editing photos or videos previously stored in the memory or received via email.
